(19) United States
(12) Patent Application Publication
(10) Pub. No.: US 2014/0306897 A1
(43) Pub. Date: Oct. 16, 2014

(54) VIRTUAL KEYBOARD SWIPE GESTURES FOR CURSOR MOVEMENT

(71) Applicant: BARNESANDNOBLE.COM LLC, New York, NY (US)

(72) Inventor: Gerald B. Cueto, San Jose, CA (US)

(73) Assignee: barnesandnoble.com llc, New York, NY (US)

(21) Appl. No.: 13/860,186

(22) Filed: Apr. 10, 2013

(51) Int. Cl. G06F 3/0488; G06F 3/041

(52) U.S. Cl. CPC G06F 3/04883; G06F 3/041; G06F 3/04886
USPC 345/173; 715/863; 715/773

(57) ABSTRACT

Techniques are disclosed for providing a virtual keyboard cursor swipe gesture mode in touch sensitive computing devices. The keyboard cursor swipe mode is configured to translate a swipe gesture (initiated on or over a virtual keyboard of the device) into cursor movement in the direction of the swipe gesture. In some instances, characteristics such as the swipe length, swipe speed, and/or number of contact points used when swiping may affect when the mode is invoked and/or the distance and/or speed of the cursor movement. The keyboard cursor swipe mode may also be configured with a highlighting feature that highlights text while the cursor is moved in combination with a highlight activation action, such as holding the shift key. In some cases, the keyboard cursor swipe mode may allow for continual cursor movement as long as the swipe gesture is held.

### FIELD OF THE DISCLOSURE

This disclosure relates to computing devices, and more particularly, to input techniques for touch sensitive devices.

### BACKGROUND

Touch sensitive computing devices such as tablets, eReaders, mobile phones, smart phones, personal digital assistants (PDAs), and other such devices are commonly used for displaying consumable content. The content may be, for example, an eBook, an online article or website, images, documents, a movie or video, or a map, just to name a few types. Such devices are also useful for displaying a user interface that allows a user to interact with one or more applications or services running on the device. In some instances, the content is displayed and interacted with using a touch screen, while in other instances, the touch sensitive surface (such as a track pad) and display device (such as a non-touch sensitive monitor) may be separate. The user interface for these touch sensitive computing devices typically include a virtual keyboard (also referred to as a soft keyboard) for entering text and other characters. The virtual keyboard is typically displayed when a user is interacting with a text entry box or other various text input fields.

### BRIEF DESCRIPTION OF THE DRAWINGS

FIGS. 1a-b illustrate an example touch sensitive computing device having a keyboard cursor swipe mode configured in accordance with an embodiment of the present invention.

FIGS. 1c-d illustrate example configuration screen shots of the user interface of the touch sensitive computing device shown in FIGS. 1a-b configured in accordance with an embodiment of the present invention.

FIG. 2a illustrates a block diagram of a touch sensitive computing device configured in accordance with an embodiment of the present invention.

FIG. 2b illustrates a block diagram of a communication system including the touch sensitive computing device of FIG. 2a configured in accordance with an embodiment of the present invention.

FIGS. 3a-i illustrate a keyboard cursor swipe mode on a touch sensitive computing device, in accordance with one or more embodiments of the present invention.

FIG. 4 illustrates a method for providing a keyboard cursor swipe mode in a touch sensitive computing device, in accordance with an embodiment of the present invention.

### DETAILED DESCRIPTION

Techniques are disclosed for providing a virtual keyboard cursor swipe gesture mode in touch sensitive computing devices. The keyboard cursor swipe mode is configured to translate a swipe gesture (performed over a virtual keyboard of the device) into cursor movement in the direction of the swipe gesture. In some instances, characteristics such as the swipe length, swipe speed, and/or number of contact points used when swiping may affect when the mode is invoked and/or the distance and/or speed of the cursor movement. The keyboard cursor swipe mode may also be configured with a highlighting feature that highlights text while the cursor is moved in combination with a highlight activation action, such as holding the shift key. In some cases, the keyboard cursor swipe mode may allow for continual cursor movement as long as the swipe gesture is held. Numerous other configurations and variations will be apparent in light of this disclosure.

General Overview

As previously explained, touch sensitive computing devices such as tablets, eReaders, and smart phones are commonly used for displaying user interfaces and consumable content. As was also explained, user interfaces for touch sensitive devices typically include a virtual keyboard for entering text and other characters into text boxes or other various text input fields. A cursor is typically used to indicate the position that will receive or otherwise respond to the key-based input via the virtual keyboard (also referred to as the insertion point). The cursor is typically displayed as a flashing or steady underscore, solid rectangle, or vertical line. When the virtual keyboard is displayed, a user may desire to move a cursor around (e.g., when a text input field is active) or provide other directional input, such as to move from cell to cell within a spreadsheet application. While most touch sensitive computing devices provide methods for moving a cursor, the methods typically require a user to tap to the desired cursor location or use unidirectional buttons to move the cursor. However, those and other known methods for cursor movement have drawbacks.

Thus, and in accordance with an embodiment of the present invention, techniques are disclosed for cursor movement using swipe gestures over the virtual keyboard of a touch sensitive computing device, referred to collectively herein as a keyboard cursor swipe mode. Since cursor movement is typically desired when entering or editing text in a text input field, such as a text entry box, the keyboard cursor swipe mode provides an intuitive mechanism for moving the cursor using the virtual keyboard. Further, the techniques disclosed herein provide additional functionality to enhance the directional input experience, particularly when dealing with touch sensitive devices that use a touch screen, such as smart phones, eReaders, and tablets. Invocation of the keyboard cursor swipe mode may be achieved in a number of ways. For instance, a multi-touch-point swipe gesture started from the virtual keyboard can be used to invoke the mode immediately, as will be apparent in light of the present disclosure. In another embodiment, a single-touch-point press-and-hold on the virtual keyboard for a given duration (e.g., 1-2 seconds, or some other suitable duration) can cause invocation of the mode.

Generally, the direction of the swipe gesture may determine the direction of the cursor movement when using one or more embodiments of the keyboard cursor swipe mode. Other various characteristics of the keyboard swipe gesture may also affect the cursor movement. For example, in some embodiments, the keyboard cursor swipe mode may be configured such that the swipe length, swipe speed, and/or number of contact points used when swiping affects the cursor movement performed. Although the swipe gestures described herein are discussed in the context of causing cursor movement, they may also relate more generally to directional input, as will be apparent in light of this disclosure. In addition, in some embodiments, the swipe gestures made using the keyboard cursor swipe mode may be interpreted as directional input to cause the cursor movement described herein.

In some embodiments, the keyboard cursor swipe mode may be configured with a highlighting feature that is triggered using a highlight activation action. The highlight activation action may include holding a stationary contact point (e.g., using the user's non-swiping hand), pre-selecting the shift key, or holding the shift key. In some instances, highlighting may be triggered by using a certain amount of contact points when performing a swipe gesture, such as three fingers, for example. The keyboard cursor swipe mode may be configured in some embodiments to allow continual (or repeated) cursor movement by holding a swipe gesture. In some such embodiments, swipes may be made relative to an anchor point (e.g., the starting contact point(s)) to allow a user to swipe in a new direction relative to the anchor point while maintaining contact to move the cursor in a new direction, as will be apparent in light of this disclosure. In some instances, the length, speed, and/or number of contact points used when making the swipes may affect the speed and/or acceleration of the continual cursor movement. For example, an embodiment may be configured such that extending a swipe gesture farther from the anchor point accelerates the continual cursor movement in the direction of the swipe.

In some embodiments, the functions performed when using a keyboard cursor swipe mode described herein may be configured at a global level (i.e., based on the UI settings of the electronic device) and/or at an application level (i.e., based on the specific application being displayed). To this end, the keyboard cursor swipe mode may be user-configurable in some cases, or hard-coded in other cases. Further, the keyboard cursor swipe mode as described herein may be included with a virtual keyboard or be a separate program/service configured to interface with a pre-existing virtual keyboard to incorporate the functionality of the keyboard cursor swipe mode as described herein (regardless of whether the virtual keyboard is UI based or application specific). For ease of reference, user input is sometimes referred to as contact or user contact; however, direct and/or proximate contact (e.g., hovering within a few centimeters of the touch sensitive surface) may be used to make the keyboard swipe gestures described herein depending on the specific touch sensitive device being used. In other words, in some embodiments, a user may be able to use the keyboard cursor swipe mode without physically touching the touch sensitive device.

Device and Configuration Examples

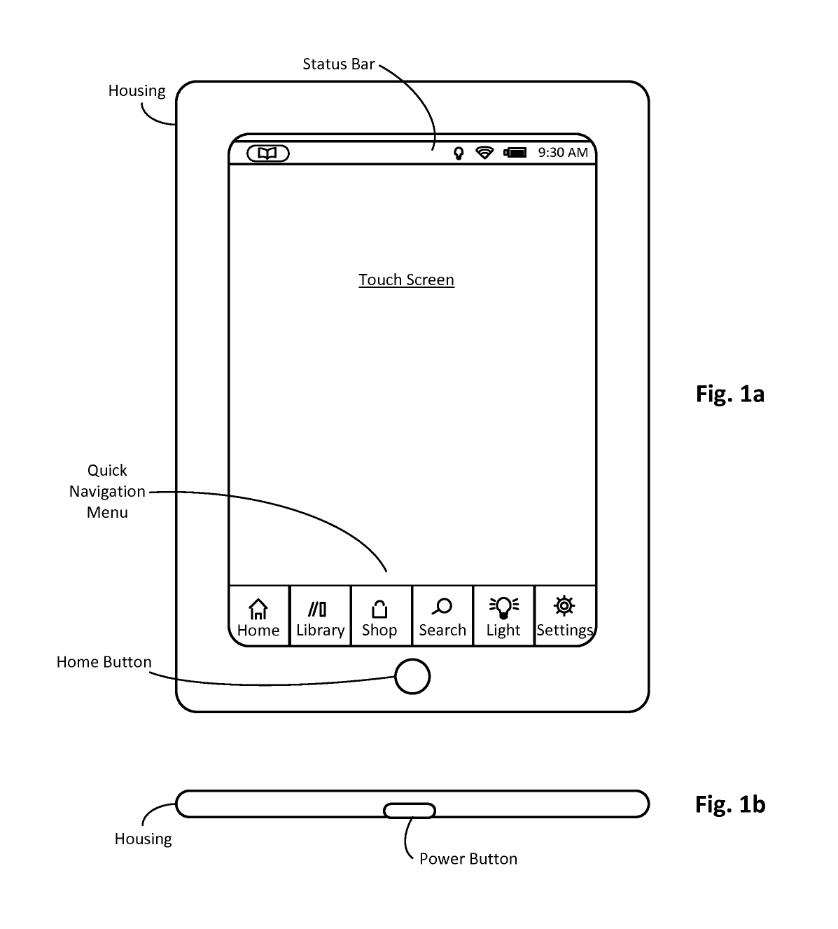

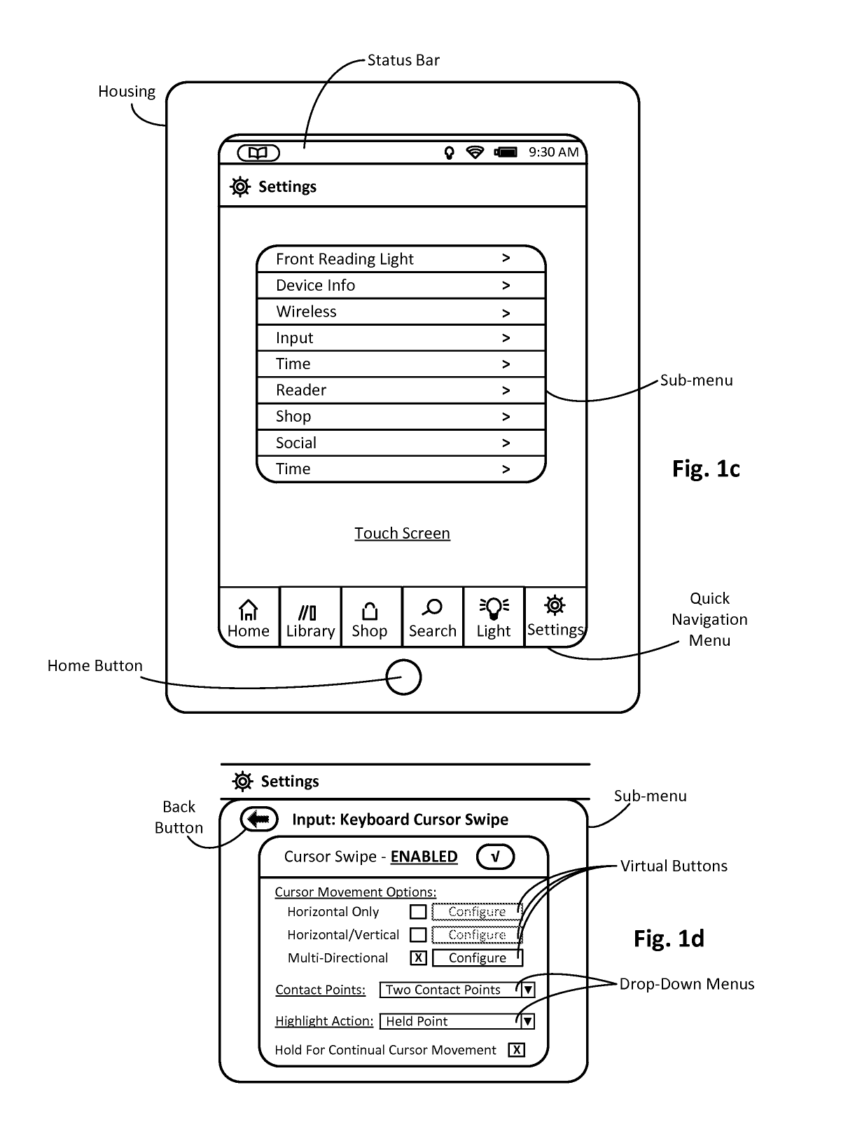

FIGS. 1a-b illustrate an example touch sensitive computing device having a keyboard cursor swipe mode configured in accordance with an embodiment of the present invention. The device could be, for example, a tablet such as the NOOK® Tablet by Barnes & Noble. In a more general sense, the device may be any electronic device having a touch sensitive user interface and capability for displaying content to a user, such as a mobile phone or mobile computing device such as an eReader, a tablet or laptop, a desktop computing system, a television, a smart display screen, or any other device having a touch screen display or a non-touch display screen that can be used in conjunction with a touch sensitive surface. As will be appreciated in light of this disclosure, the claimed invention is not intended to be limited to any particular kind or type of electronic device.

As can be seen with this example configuration, the device comprises a housing that includes a number of hardware features such as a power button and a press-button (sometimes called a home button herein). A touch screen based user interface (UI) is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to hide a displayed virtual keyboard. Numerous other configurations and variations will be apparent in light of this disclosure, and the claimed invention is not intended to be limited to any particular set of hardware buttons or features, or device form factor.

As can be further seen, the status bar may also include a book icon (upper left corner). In some such cases, the user can access a sub-menu that provides access to a keyboard cursor swipe mode configuration sub-menu by tapping the book icon of the status bar. For example, upon receiving an indication that the user has touched the book icon, the device can then display the keyboard cursor swipe mode configuration sub-menu shown in FIG. 1d. In other cases, tapping the book icon may just provide information on the content being consumed. Another example way for the user to access a keyboard cursor swipe mode configuration sub-menu such as the one shown in FIG. 1d is to tap or otherwise touch the Settings option in the quick navigation menu, which causes the device to display the general sub-menu shown in FIG. 1c. From this general sub-menu the user can select any one of a number of options, including one designated Input in this specific example case. Selecting this sub-menu item (with, for example, an appropriately placed screen tap) may cause the keyboard cursor swipe mode configuration sub-menu of FIG. 1d to be displayed, in accordance with an embodiment. In other example embodiments, selecting the Input option may present the user with a number of additional sub-options, one of which may include a so-called keyboard cursor swipe option, which may then be selected by the user so as to cause the keyboard cursor swipe mode configuration sub-menu of FIG. 1d to be displayed. Any number of such menu schemes and nested hierarchies can be used, as will be appreciated in light of this disclosure.

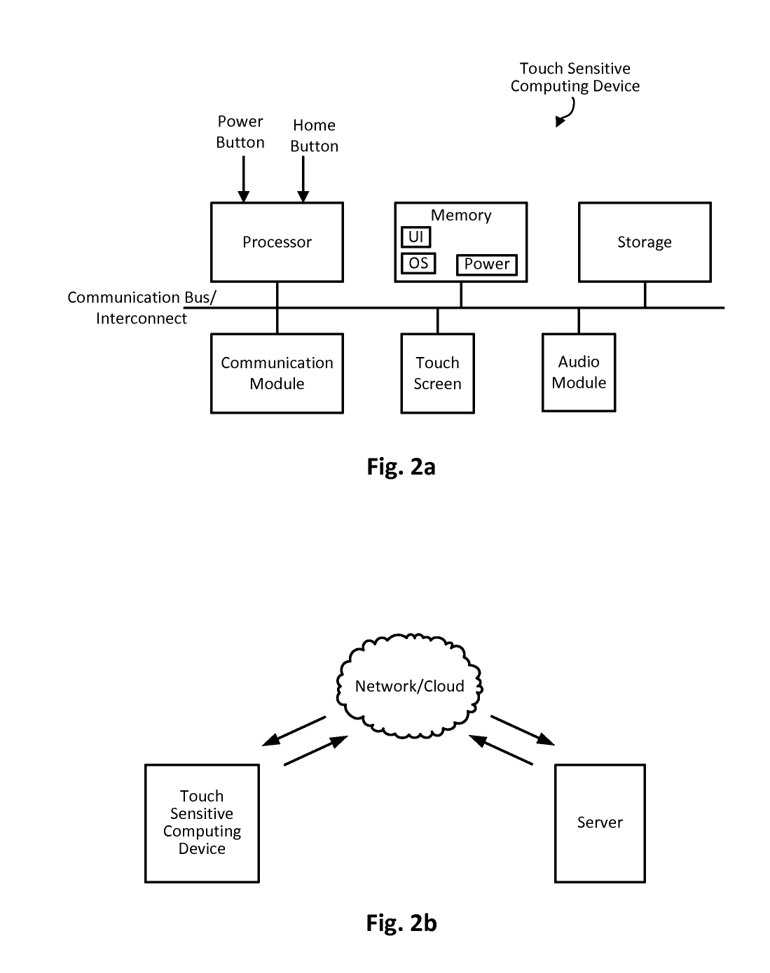

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). Additional example details of the underlying OS and circuitry in accordance with some embodiments will be discussed in turn with reference to FIG. 2a. In some cases, the keyboard cursor swipe mode may be automatically configured by the specific UI or application being used. In these instances, the keyboard cursor swipe mode need not be user-configurable (e.g., if the keyboard cursor swipe mode is hard coded or is otherwise automatically configured).

As previously explained, and with further reference to FIGS. 1c and 1d, once the Settings sub-menu is displayed (FIG. 1c), the user can then select the Input option. In response to such a selection, the keyboard cursor swipe mode configuration sub-menu shown in FIG. 1d can be provided to the user. In this example case, the keyboard cursor swipe mode configuration sub-menu includes a UI check box that when checked or otherwise selected by the user, effectively enables the keyboard cursor swipe mode (shown in the enabled state); unchecking the box disables the mode. Other embodiments may have the keyboard cursor swipe gesture mode always enabled, or enabled by a switch or button, for example. In some instances, the keyboard cursor swipe mode may be automatically enabled in response to an action, such as when a virtual keyboard is displayed and/or a text input field is active (i.e., interaction with the virtual keyboard will enter text at the cursor location). As previously described, the user may be able to configure some of the features with respect to the keyboard cursor swipe mode, so as to effectively give the user a say in, for example, when the keyboard cursor swipe mode is available and/or how it is invoked, if so desired.

In the example case shown in FIG. 1d, once the keyboard cursor swipe mode is enabled, the user can choose one of the Cursor Movement Options, which determines how swipe gestures over the virtual keyboard are translated into cursor movement. The available Cursor Movement Options in this example case include Horizontal Only, Horizontal/Vertical, and Multi-Directional. The Horizontal Only cursor movement only moves the cursor left and right in response to leftward horizontal swipes and rightward horizontal swipes over the virtual keyboard, respectively. In other words, the Horizontal Only option allows the cursor to move in two directions (left and right); however, when the cursor is at the beginning of a line, a left cursor movement may cause the cursor to go to the end of the previous line and when the cursor is at the end of a line, a right cursor movement may cause the cursor to go to the beginning of the next line. In one example case, when the keyboard cursor swipe mode is setup with the Horizontal Only Cursor Movement Option, the mode may be configured to translate any swipe that is more-so leftward relative to the virtual keyboard as leftward cursor movement and any swipe that is more-so rightward relative to the virtual keyboard as rightward cursor movement. In another example case, the angles at which swipes will be recognized may be varied, and the angles may be either hard-coded, user-configurable, or some combination thereof. For example, the swipe angles for horizontal cursor movement may only extend 15, 30, 45, 60, or 75 degrees on either side of a horizontal line relative to the virtual keyboard orientation, and swipe gestures at angles greater than the set limit (e.g., 75 degrees) can be ignored, in some embodiments.

Continuing with the other Cursor Movement Options, the Horizontal/Vertical cursor movement would allow the cursor to move left and right in response to leftward rightward horizontal swipes, respectively, over the virtual keyboard and also move the cursor up and down in response to upward and downward vertical swipes, respectively, over the virtual keyboard. In other words, the Horizontal/Vertical option allows cursor movement in four directions, i.e., left, right, up, and down. The swipe gesture recognition range for each direction may be varied and/or configurable, as previously described. The Multi-Directional option allows cursor movement in any direction (including diagonal movement) in response to a swipe over the virtual keyboard in that direction. As shown, the Multi-Directional option is enabled/selected.

Continuing with the example case shown in FIG. 1d, the Cursor Movement Options selection may be configured using the respective Configure virtual button. The Configure options available may relate to various functions of the keyboard cursor swipe mode. Some of these options, such as the effect of the speed, length, and/or number of contacts points used when making swiping gestures over a virtual keyboard for cursor movement will be apparent in light of this disclosure. The keyboard cursor swipe example settings screen shown in FIG. 1d also allows a user to configure the number of contact points needed to invoke the mode. This may be an exact number or a minimum number. As shown, this option is set to Two Contact Points, meaning that two contact points (e.g., two fingers) are needed to invoke the mode, i.e., to move the cursor when making swiping gestures over a virtual keyboard, in this example configuration. The drop-down menu may present other selectable configurations, such as One Contact Point, Three Contact Points, etc. In some other example cases, an activation action may be needed to invoke the cursor swipe mode, such as holding a button (e.g., a physical button such as the home button or a virtual button such as a keyboard cursor swipe mode key), as will be apparent in light of this disclosure. As will be appreciated in light of this disclosure, when only one contact point is needed to invoke the mode as described herein, swipe gestures may have to include an initial press-and-hold for a certain duration and/or may have to be made over multiple keys to be recognized and distinguished from a simple key press or tap, so as to cause cursor movement. In some such cases, note that a character corresponding to the initial key press may appear on the screen at the current cursor position but may then disappear as it becomes clear that the cursor swipe mode has been invoked.

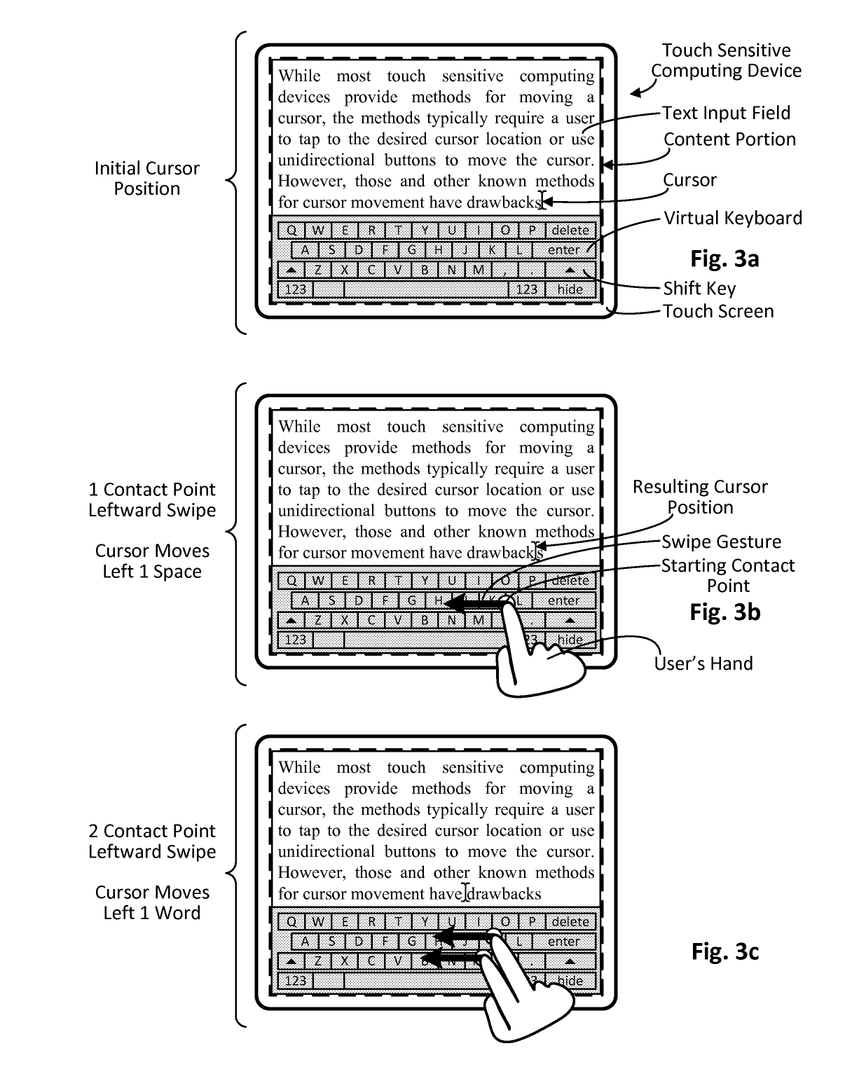

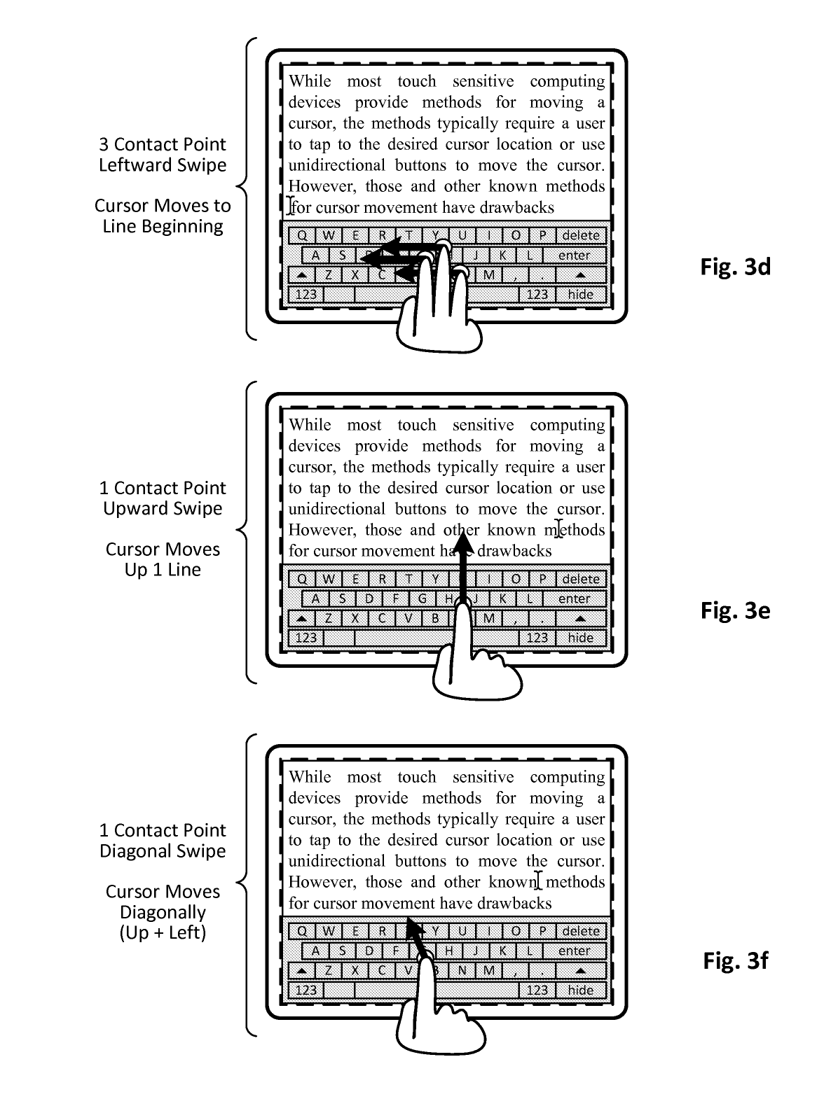

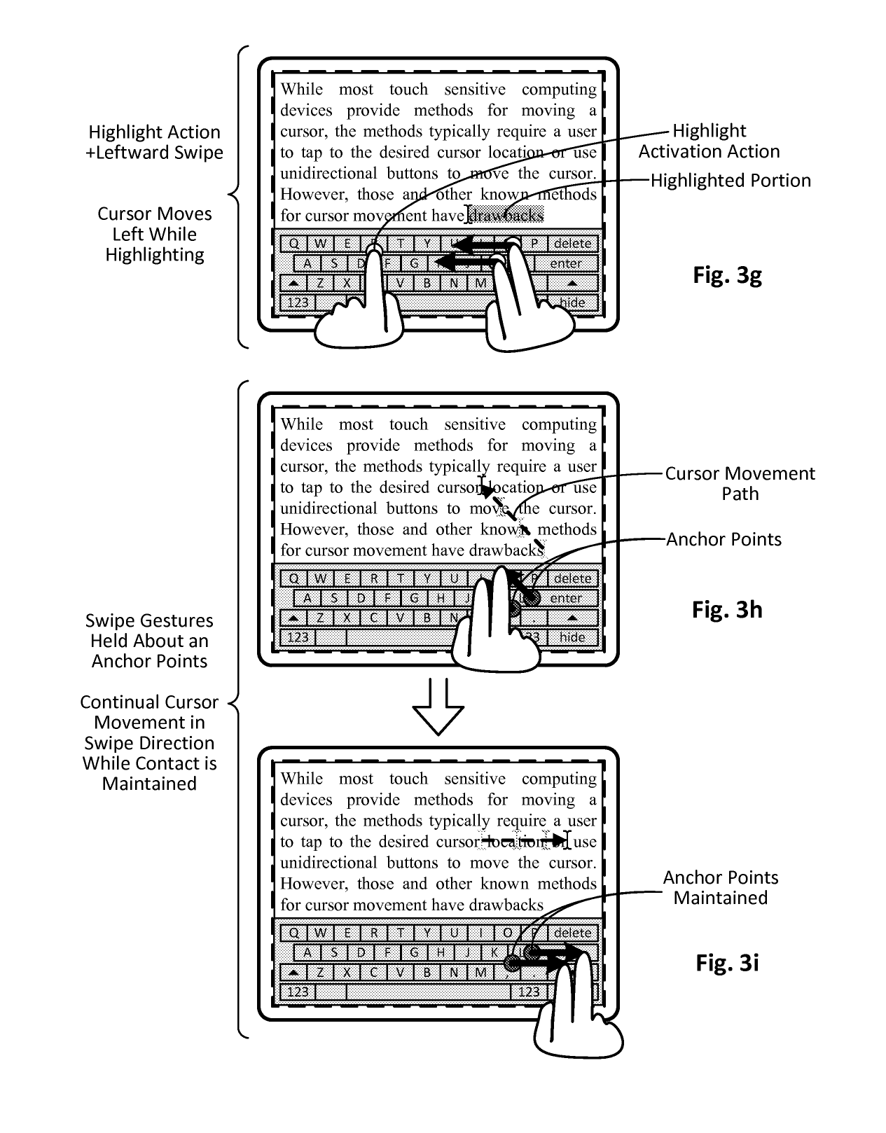

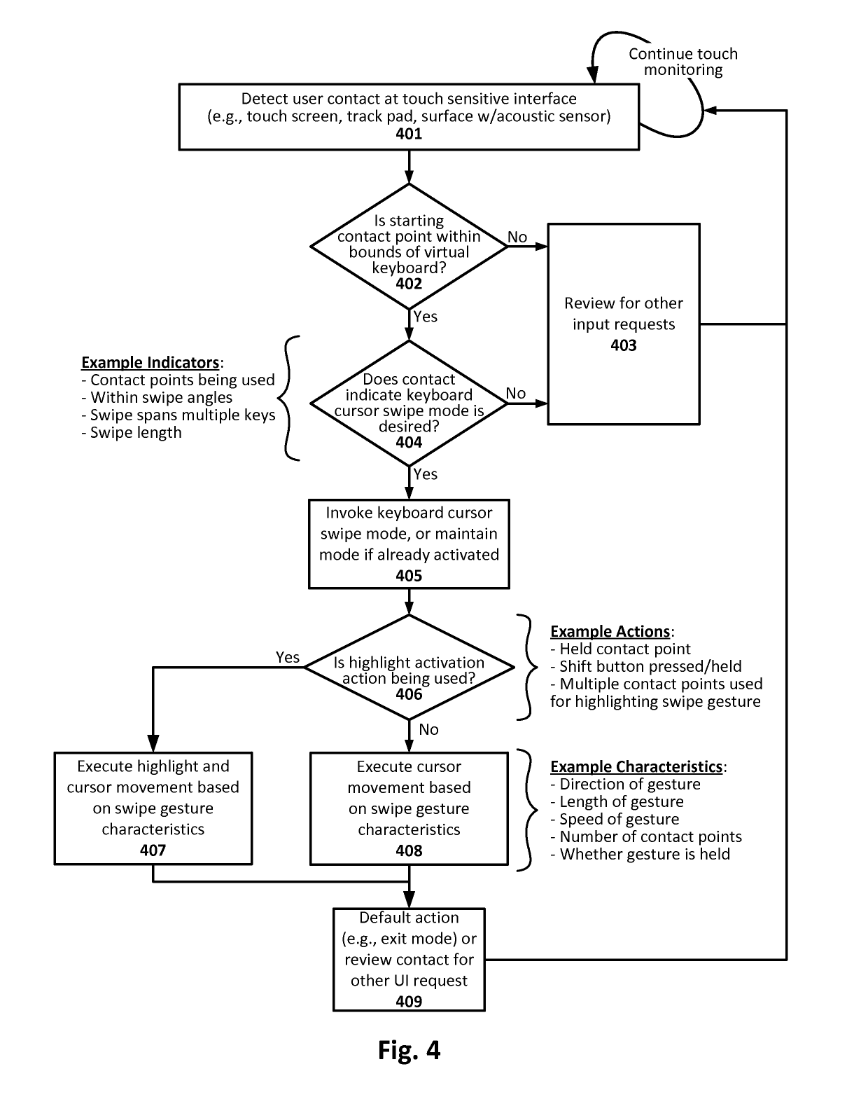

The next settings option in the example case shown in FIG. 1d allows a user to select the Cursor Swipe Highlight activation action. The activation action selected in this example case is a Held Point, i.e., the user can highlight sections of text by holding a non-moving contact point when making swipe gestures over the virtual keyboard for cursor movement. This feature will be discussed in further detail with reference to FIGS. 3g and 4. The drop-down menu may present other selectable actions that activate cursor swipe highlighting, such as holding a button (e.g., a physical button such as the home button or a virtual button such as the shift key). The other customizable option shown in the example of FIG. 1d is whether a user can Hold For Continual Cursor Movement, i.e., whether a held swipe gesture will cause continual cursor movement. For example, enabling this feature may allow for continual or repeated cursor movement in the direction of the swipe gesture when the gesture made is held. This feature may also allow cursor movement in multiple directions around an anchor point (such as the starting contact point(s)) while maintaining contact. This feature will be discussed in further detail with reference to FIGS. 3h-i and 4. Any number of features of the keyboard cursor swipe mode may be configurable, but they may also be hard-coded as previously explained. Numerous configurations and features will be apparent in light of this disclosure.

In other embodiments, the user may specify a number of applications in which the keyboard cursor swipe mode can be invoked. Such a configuration feature may be helpful, for instance, in a tablet or laptop or other multifunction computing device that can execute different applications (as opposed to a device that is more or less dedicated to a particular application). In one example case, for instance, the available applications could be provided along with a corresponding check box. Example diverse applications include an eBook application, a document editing application, a text or chat messaging application, a browser application, a file manager application, a word processor application, a document viewer application, or any application including text based search, to name a few. In other embodiments, the keyboard cursor swipe mode can be invoked whenever the virtual keyboard application is running or is displayed on the screen, regardless of the application being used. Any number of applications or device functions may benefit from a keyboard cursor swipe mode as provided herein, whether user-configurable or not, and the claimed invention is not intended to be limited to any particular application or set of applications.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind.

Architecture

FIG. 2a illustrates a block diagram of a touch sensitive computing device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's physical contact with the surface (e.g., touching the surface with a finger or an implement, such as a stylus) into an electronic signal that can be manipulated or otherwise used to trigger a specific user interface action, such as those provided herein. The principles provided herein equally apply to any such touch sensitive devices. For ease of description, examples are provided with touch screen technology.

The touch sensitive surface (touch sensitive display in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (e.g., with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and active stylus input. In still other embodiments, the touch screen display may be configured with only an active stylus sensor. In any such embodiments, a touch screen controller may be configured to selectively scan the touch screen display and/or selectively report contacts detected directly on or otherwise sufficiently proximate to (e.g., within a few centimeters) the touch screen display. Numerous touch screen display configurations can be implemented using any number of known or proprietary screen based input detecting technology.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a virtual keyboard cursor swipe mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments® OMAP3621 applications processor), and may include one or more co-processors or controllers to assist in device control. In this example case, the processor receives input from the user, including input from or otherwise derived from the power button, home button, and touch sensitive surface. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 6-inch E-ink Pearl 800×600 pixel screen with Neonode® zForce® touch screen, or any other suitable display and touch screen interface technology. The communications module can be, for instance, any suitable 802.11 b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smart phone and tablet applications and larger for smart computer monitor and laptop applications.

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms, or other platforms including a virtual keyboard. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touch screen technology, and the various example screen shots and example use-cases shown in FIGS. 1a, 1c-d, and 3a-i, in conjunction with the keyboard cursor swipe mode methodologies demonstrated in FIG. 4, which will be discussed in turn. The audio module can be configured, for example, to speak or otherwise aurally present a selected eBook or other textual content, if preferred by the user. In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the touch sensitive computing device of FIG. 2a, configured in accordance with an embodiment of the present invention. As can be seen, the system generally includes a touch sensitive computing device that is capable of communicating with a server via a network/cloud. In this example embodiment, the touch sensitive computing device may be, for example, an eReader, a mobile phone, a smart phone, a laptop, a tablet, a desktop computer, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server may be configured to remotely provision a keyboard cursor swipe mode as provided herein to the touch sensitive device (e.g., via JavaScript or other browser based technology). In other embodiments, portions of the methodology may be executed on the server and other portions of the methodology may be executed on the device. Numerous server-side/client-side execution schemes can be implemented to facilitate a keyboard cursor swipe mode in accordance with one or more embodiments, as will be apparent in light of this disclosure.

Keyboard Swipe Gesture Examples

FIGS. 3a-i illustrate a keyboard cursor swipe mode on a touch sensitive computing device, in accordance with one or more embodiments of the present invention. As shown in FIG. 3a, the device includes a frame that houses a touch sensitive surface, which in this example, is a touch screen display. In some embodiments, the touch sensitive surface may be separate from the display, such as is the case with a track pad. In this example embodiment, the touch screen display contains a content portion (within the dashed line area). As previously described, any touch sensitive surface for receiving user input (e.g., via direct contact or hovering input) may be used for keyboard cursor swipe gestures as described herein. The keyboard cursor swipe gestures may be made by a user's hand(s) and/or by one or more implements (such as a stylus or pen), for example. The keyboard cursor swipe gestures and resulting cursor movements shown in FIGS. 3b-i are provided for illustrative purposes only and are not exhaustive of all possible keyboard cursor swipe mode configurations and features, and are not intended to limit the claimed invention.

FIG. 3a shows a text input field in the upper part of the content portion and a virtual keyboard in the lower part, as may be displayed, for example, in a word processing or messaging application. The text input field may be any field or box that allows the entry of text and/or other characters via a virtual keyboard, for example. A cursor is typically displayed in the text input field when the field is active (such as is the case in this example screen shot) to indicate the position in the field that will receive or otherwise respond to input from the virtual keyboard (or other input mechanisms). In some instances, the virtual keyboard will always be displayed, while in other instances, the virtual keyboard will appear or only be displayed when a text input field becomes active, such as when a user selects the text input field (e.g., with an appropriately positioned tap).

Virtual keyboards capable of using a keyboard cursor swipe mode as disclosed herein may have any layout or configuration, such as the QWERTY keyboard layout as shown in FIG. 3a, a numerical keyboard, a foreign language keyboard, or any other layout including multiple buttons or keys. In some instances, the virtual keyboard may have multiple selectable layouts. Although the virtual keyboard is shown in this example embodiment as a part of the display, in other embodiments, the virtual keyboard may have a different format, such as an optically projected keyboard layout or other optical detection system for keyboard input, for example. A user can interact with the virtual keyboard by making direct or proximate contact with a particular key to select/input that particular key. For example, an appropriately positioned tap (or hover input) on an alpha-numeric key, such as the “H” key, inputs that alpha-numeric (i.e., the letter “H”) at the cursor location. Further, selection of non-alphanumeric keys may cause various functions. For example, the shift key is a modifier key that can be used for various functions, such as to change the case of letters (uppercase vs. lowercase) or to cause highlighting in combination with cursor movement using the keyboard cursor swipe mode as described herein.

FIG. 3a shows the cursor in the initial cursor position, i.e., the position the cursor is in before performing any of the keyboard cursor swipe gesture examples illustrated in FIGS. 3b-h, thereby providing a starting reference point for the resulting cursor positions. Various keyboard swipe gestures may be used to perform cursor movements and/or other cursor movement-related functions (such as highlighting), as will be apparent in light of this disclosure. In general, the direction of the swipe gesture determines the direction of the cursor movement. Other various characteristics of the keyboard swipe gesture may also affect the cursor movement. In some example cases, the length of the swipe gesture may affect the cursor movement. For example, a longer swipe may result in increased or faster cursor movement. In some example cases, the speed of the swipe gesture may affect the cursor movement. For example, faster swipes may result in increased or faster cursor movement. In some example cases, the number of contact points used when swiping may affect the cursor movement. For example, a minimum number of contact points may be required to move the cursor (e.g., two fingers or three fingers), additional contact points may result in increased or faster cursor movement (e.g., two fingers moves cursor at two times speed, three fingers at three times speed), and/or highlighting may be triggered when using additional contact points (e.g., two fingers cause cursor movement and three fingers cause cursor movement plus highlighting). Note that the number of contact points can be used to distinguish a simple key selection from a desire to invoke the keyboard cursor swipe mode. Other various characteristics of the swipe gestures may affect cursor movement, as will be apparent in light of this disclosure.

FIG. 3b shows an example horizontal swipe gesture for cursor movement, in accordance with an embodiment of the present invention. More specifically, a one contact point leftward swipe gesture is being performed to cause the cursor to move left one space from the initial position shown in FIG. 3a. In the example case shown in FIG. 3b, the swipe gesture is being made by a user's hand (specifically one finger since only one contact point is being used). As previously described, the swipe gesture could be made in other ways, such as by using a mouse, stylus, or other suitable input technique, and may include multiple contact points. The swipe gesture has a starting contact point which is designated with a circle for purposes of illustration. The starting contact point(s) and/or path of the swipe gesture may be indicated on the display of the touch sensitive computing device to provide visual feedback, in accordance with an example embodiment. In other example embodiments, other feedback may be provided, such as aural or haptic, depending upon the configuration of the keyboard cursor swipe mode.

As previously described, the cursor movement can be determined by at least the direction of the swipe gesture. The swipe gesture is made by initiating contact (at one or more starting contact points) and maintaining the contact while swiping in a certain direction to cause the desired cursor movement. Since one contact point is being used in this example case, the keyboard cursor swipe mode may be configured such that the swipe gesture may have to, for example, be initiated with a press-and-hold (e.g., for 1-2 seconds, or some other suitable duration) and/or be made across multiple keys to cause cursor movement, so as to be distinguished from a desire to enter a letter/character. In some instances, swipe gestures may be required to be made across three or more keys to cause cursor movement when using one contact point to avoid undesired cursor movement. In other instances, two or more contact points can be used to immediately differentiate a key press or tap (e.g., for letter/character input) from an invocation of the keyboard cursor swipe mode (to cause cursor movement).

As previously described, the length, speed, and/or number of contact points of the swipe gestures may affect the cursor movement. For example, the leftward swipe gesture in FIG. 3b is made with one contact point to cause the cursor to move left one space, the leftward swipe gesture in FIG. 3c is made with two contact points to cause the cursor to move left one word, and the leftward swipe gesture in FIG. 3d is made with three contact points to cause the cursor to move to the line beginning (e.g., it performs a home function). Alternatively, the result of a rightward horizontal swipe gesture would cause the cursor to move right one space (e.g., swiping with one finger), right one word (e.g., swiping with two fingers), or to the line end/perform end function (e.g., swiping with three fingers). In another example case, more contact points may only increase the number of spaces moved (e.g., one contact point swipe moves the cursor one space, two contact point swipe moves the cursor two spaces, etc.). In yet another example case, the length of the swipe gesture may allow for different cursor movement, such as, the cursor movement results shown in FIGS. 3b-d (e.g., if the swipe gesture performed in FIG. 3b is made at a first length then it causes the cursor to move left one word, if it is made at a second length then it causes the cursor to move left one word, and if it is made at a third length then it causes the cursor to move left to the beginning of the line). In another example case, the speed of the swipe gestures may allow for different cursor movement to perform, for example, the three cursor movement results shown in FIGS. 3b-d (e.g., if the swipe gesture performed in FIG. 3b were made at a first speed then it causes the cursor to move left one space, if it were made at a second speed then it causes the cursor to move left one word, and if it were made at a third speed then it causes the cursor to move left to the beginning of the line). In a more general sense, any one of more features of the keyboard-based swipe gesture can be used to selectively invoke and execute cursor movement and/or directional input.

FIG. 3e shows an example vertical swipe gesture for cursor movement. More specifically, a one contact point upward swipe gesture is being performed to cause the cursor to move up one line from the initial position shown in FIG. 3a. The previously provided description regarding the characteristics of the swipes as illustrated with horizontal swipes also applies to vertical swipes. For example, in one embodiment, the keyboard cursor swipe mode may be configured such that a one contact point vertical swipe moves the cursor one line, a two contact point vertical swipe moves the cursor one paragraph (or scrolls one page), and a three contact point vertical swipe moves the cursor to the first or last line (depending on the direction). Alternatively, the cursor movement may correspond to the length of the swipe, in some cases. FIG. 3e also illustrates that the swipe gestures for cursor movement described herein do not require that the entire swipe gesture be performed within the bounds of the virtual keyboard. In some instances, only the starting contact point for the swipe gestures may be required to be within the bounds of the virtual keyboard to cause proper cursor movement. For example, the upward swipe shown has a starting contact point on the virtual keyboard, but the end of the swipe is performed over the text input field. Therefore, the keyboard cursor swipe gesture mode may be configured in some embodiments to recognize swipe gestures even if they venture outside of the virtual keyboard, as long as the starting contact points are on (or over, using e.g., hovering input) the virtual keyboard and that direct (or proximate) contact is maintained throughout the swipe gesture.

FIG. 3f shows an example diagonal swipe gesture for cursor movement. More specifically, a one contact upward-leftward diagonal swipe gesture is being performed to cause the cursor to move diagonally up and left from the initial position shown in FIG. 3a. As previously described, the keyboard cursor swipe mode may be configured to recognize different types of swipe gestures, such as only horizontal swipes, horizontal and vertical swipes, or multi-directional swipes. In some instances, the keyboard cursor swipe mode may be hard-coded with one of these options, while in other instances the options may be user-configurable (e.g., see FIG. 1d). The diagonal swipe shown in FIG. 3f may perform as a diagonal cursor movement if the keyboard cursor swipe mode is configured with the multi-directional swipe gesture recognition option. Such directional tracking between gesture movement and cursor movement may provide a more intuitive user experience. In another configuration, if the keyboard cursor swipe mode only recognizes horizontal swipe gestures, then the diagonal swipe gesture shown in FIG. 3f may be interpreted as a leftward swipe (since it is more left than right) and thereby cause the cursor to move left one space (similar to FIG. 3b). In yet another configuration, if the keyboard cursor swipe mode only recognizes horizontal and vertical swipe gestures, then the diagonal swipe gesture shown in FIG. 3f may be interpreted as an upward swipe (since it is closest to the up direction) and thereby cause the cursor to move up one line (similar to FIG. 3e).

FIG. 3g shows an example highlight action and swipe gesture for cursor movement plus highlighting, in accordance with an embodiment of the present invention. More specifically, a held stationary contact point highlight activation action (made by user's left hand) plus a one or two point contact (two shown in this example) leftward swipe gesture (made by user's right hand) is being performed to cause the cursor to move to the left while highlighting from the initial position shown in FIG. 3a to the end of the gesture (so as to highlight a word, in this example case). As previously described, the highlight activation action may include various actions such as selecting the shift key/function before performing swipe gestures for cursor movement, holding the shift key while performing swipe gestures for cursor movement, or holding a contact point while performing the swipe gesture, such as in the example shown in FIG. 3g. Therefore, when using the highlighting feature, the swipe gestures cause cursor movement as described herein, but also perform the additional function of highlighting as the cursor moves.

FIGS. 3h-i show an example swipe gesture and hold for continual cursor movement, in accordance with various embodiments. The example swipe gestures illustrated in FIGS. 3b-g were described herein as performing one cursor movement in response to the one swipe gesture. However, the keyboard cursor swipe mode may be configured to allow a user to hold down swipe gestures for continual (or repeated) cursor movement. For example, in FIG. 3h, the user is providing a two finger diagonal swipe gesture in the direction shown to move the cursor diagonally in a corresponding direction and distance as indicated by the cursor movement path (designated by a dotted arrow). The speed and/or acceleration of the continual cursor movement may be affected by the characteristics of the swipe gesture, such as the length, speed, and/or number of contact points used when making the swipe gesture. For example, a user may be able to move the cursor faster in the swipe direction by swiping farther from the anchor point (e.g., the starting contact point(s)), by swiping faster from the anchor point, and/or by swiping with more contact points (e.g., with more fingers) from the anchor point. In this manner, the characteristics of the swipe gesture may control the cursor movement distance and/or speed when holding the swipe gesture for continual (or repeated) cursor movement, in accordance with an embodiment.

FIG. 3i illustrates holding the gesture down and swiping in a different direction to continue cursor movement in the new direction, in accordance with another embodiment of the present invention. As previously described, if the keyboard cursor swipe mode is configured with a swipe gesture and hold for continual movement feature, then it may also allow for continual movement in any direction about the anchor point (e.g., the starting contact point(s)). For example, after the continual cursor movement shown in FIG. 3h to move the cursor diagonally as shown, the user can switch to a new swipe direction (relative to the anchor point) to move the cursor in that new direction, such as the rightward direction shown in FIG. 3i. In a more general sense, continual movement may be based on the direction of a continued swipe, whether pausing along the way or not, but while maintaining contact in a direct or sufficiently proximate manner. In these cases, anchor point(s) may be established at a given pause point(s) in the swipe gesture, to allow cursor movement to continue in the direction of continued swipes from the pauses. Therefore, a user may be able to continue cursor movement in any direction desired by maintaining the swipe gesture contact (whether direct or proximate) on the virtual keyboard to reach a final desired cursor location.

In some embodiments, the swipe gesture techniques provided herein for cursor movement may also be used to perform more general arrow key functions or directional input. As previously described, the swipe gestures for cursor movement described herein may be started from a virtual keyboard of the UI of a touch sensitive computing device and the UI may interpret the swipes as directional input (e.g., causing cursor movement when a text box is active). The virtual keyboard is generally displayed when there is an active input field (e.g., an active text box) allowing for input from that virtual keyboard. However, in some cases, the virtual keyboard may be displayed in other situations (i.e., it may be displayed when no input field is displayed or active), such as if the user selects to always display the virtual keyboard or continually displayed the virtual keyboard in a specific application, for example. In some such situations, the swipe gestures used for the keyboard cursor swipe mode described herein may be used for more general directional input. For example, in a spreadsheet application, the swipe gestures on the virtual keyboard described herein may be used to navigate cells within the spreadsheet document when a cell is selected but not active. In another example situation, when an object or graphic is selected (and no input fields are active), the swipe gesture techniques may be used to subsequently move that selected object/graphic. In some such example embodiments, the same swipe gestures and features for cursor movement may be used instead for general directional input (e.g., to move the selected object/graphic in this example case). Numerous different virtual keyboard cursor swipe gestures and configurations will be apparent in light of this disclosure.

Methodology

FIG. 4 illustrates a method for providing a keyboard cursor swipe mode in a touch sensitive computing device, in accordance with an embodiment of the present invention. This example methodology may be implemented, for instance, by the UI module of the touch sensitive device shown in FIG. 2a, or the touch sensitive device shown in FIG. 2b (e.g., with the UI provisioned to the client by the server). To this end, the UI can be implemented in software, hardware, firmware, or any combination thereof, as will be appreciated in light of this disclosure.

As can be seen, the method generally includes sensing a user's input by a touch sensitive surface. In general, any touch sensitive device may be used to detect contact with it by one or more fingers and/or styluses or other suitable implements. Since contact is location specific relative to the displayed content, the UI can detect whether the contact starts and continues on a displayed virtual keyboard. As soon as the user begins to drag or otherwise move the contact point(s) (i.e., starting contact point(s)), the UI code (and/or hardware) can assume a swipe gesture has been engaged and track the path of each contact point with respect to any fixed point within the touch surface until the user stops engaging the touch sensitive surface. The release point can also be captured by the UI as it may be used to execute or stop executing (e.g., in the case of holding for continual cursor movement) the action started when the user pressed on the touch sensitive surface. In a similar fashion, whether the user is performing a highlight activation action prior to or in combination with one or more swipe gestures can also be captured by the UI to perform highlighting as described herein. These main detections can be used in various ways to implement UI functionality, including a keyboard cursor swipe mode as variously described herein, as will be appreciated in light of this disclosure.

In this example case, the method includes detecting 401 user contact at the touch sensitive interface. In general, the touch monitoring is effectively continuous. The method continues with determining 402 if the starting contact point is within the bounds of a virtual keyboard. This may include an initial step of determining whether a virtual keyboard is being displayed. If a virtual keyboard is not displayed or user contact does not start on the virtual keyboard, then the method may continue with reviewing 403 the contact for some other UI request (e.g., select a file, send an email, etc.). If a virtual keyboard is displayed and the starting contact point of user contact is on the virtual keyboard, the method then determines 404 if the contact indicates the keyboard cursor swipe mode is desired.

The specific configuration of the keyboard cursor swipe mode may affect whether contact (direct or proximate) indicates if the keyboard cursor swipe mode is desired 404. For example, as previously explained, a minimum (or exact) number of contact points may be set to invoke the keyboard cursor swipe mode. Other characteristics of the swipe gesture may also contribute to the determination of whether contact indicates that a keyboard cursor swipe mode is desired, such as whether the swipe is within a recognized swipe angle range, whether the swipe spans multiple keys, and/or whether the swipe length is adequate to invoke the mode, for example. In any case, if the contact does not indicate that the keyboard cursor swipe mode is desired, then the method may continue with reviewing 403 the contact for other input requests. On the other hand, if the contact does indicate that the keyboard cursor swipe mode is desired, the method continues with invoking 405 the keyboard cursor swipe mode, or otherwise maintaining the mode if already invoked/activated.

The method continues with identifying 406 whether a highlight activation action is being used. As previously described, in some instances, the highlight activation action may be distinct from the swipe gesture for cursor movement, such as a held stationary contact point, pre-pressing/selecting the shift button, or holding the shift button. In some other instances, the characteristics of the swipe gesture may indicate that highlighting is desired, such as if the keyboard cursor swipe mode was configured to highlight when swiping with multiple contact points, such as three contact points (e.g., three fingers). In any case, if a highlight activation is being used, whether that action is external from or inherent to the swipe gesture for cursor movement, then the method may continue with highlighting 407 in combination with the cursor movement based on the swipe gesture characteristics. On the other hand, if a highlight activation action is not being used, the method continues by executing cursor movement 408 based on the swipe gesture characteristics. As previously described, example characteristics of the swipe gesture for cursor movement may include the direction of the gesture, the length of the gesture, the speed of the gesture, the number of contact points used for the gesture, and/or whether the gesture is being held. The configuration of the keyboard cursor swipe mode may also affect the cursor movement executed. For example, as previously described, the keyboard cursor swipe mode may be configured such that appropriate swipe gestures for cursor movement are translated into one of the following categories of cursor movement: horizontal only, horizontal and vertical only, or multi-directional. Recall that the mode may be configured by the user to a given extent, in some embodiments. Other embodiments, however, may be hard-coded or otherwise configured to carry out certain specific actions without allowing for user configuration, as will be further appreciated in light of this disclosure.

After the cursor movement has been performed in response to the swipe gesture(s) made on or otherwise initiated from the virtual keyboard, the method continues with a default action 409, such as exiting the keyboard cursor swipe mode or doing nothing until further user contact/input is received. Likewise, the received contact can be reviewed for some other UI request, as done at 403. The method may continue in the touch monitoring mode indefinitely or as otherwise desired, so that any contact provided by the user can be evaluated for use in the keyboard cursor swipe mode if appropriate. As previously indicated, the keyboard cursor swipe mode may be configured to be exited by, for example, the user releasing the ending contact point or pressing a release mode UI feature such as the home button or a touch screen feature. In some instances, the keyboard cursor swipe mode may be tied to the virtual keyboard such that it will only be available when a virtual keyboard is being displayed. In this instance, power and/or memory may be conserved since the keyboard cursor swipe mode will only run or otherwise be available when the virtual keyboard is displayed.

Numerous variations and embodiments will be apparent in light of this disclosure. One example embodiment of the present invention provides a device including a display for displaying content to a user, and a touch sensitive surface for allowing user input. The device also includes a user interface including a virtual keyboard wherein a swipe gesture performed on the virtual keyboard without regard to the starting contact point causes cursor movement determined by the direction of the swipe gesture. In some cases, the display is a touch screen display that includes the touch sensitive surface. In some cases, the cursor movement is based on the swipe gesture length, swipe gesture speed, number of contact points used for the swipe gesture and/or whether the swipe gesture is held. In some cases, a path and/or starting point of the swipe gesture is indicated on the display to provide visual feedback. In some cases, the swipe gesture is made using two or more fingers. In some cases, the swipe gesture is made using two or more fingers and cursor movement tracks direction of the swipe gesture. In some cases, the cursor movement in response to swipe gestures performed on the virtual keyboard is user-configurable.

Another example embodiment of the present invention provides a mobile computing device including a display having a touch screen interface and for displaying content to a user, and a user interface including a virtual keyboard and a keyboard cursor swipe mode that is configured to be invoked in response to user contact via the touch sensitive interface, the user contact including a swipe gesture starting on the virtual keyboard and causing cursor movement determined by the direction of the swipe gesture, wherein the length, speed, and/or number of contact points of the swipe gesture defines the distance and/or speed of the cursor movement. In some cases, the keyboard cursor swipe mode is configured to translate swipe gestures into only horizontal cursor movement, only horizontal and vertical cursor movement, or multi-directional cursor movement. In some cases, the keyboard cursor swipe mode is configured to cause continual cursor movement in response to held swipe gestures. In some cases, the keyboard cursor swipe mode is configured to set the start of the swipe gesture as an anchor point about which the user can swipe to cause continual cursor movement. In some such cases, the anchor point is displayed to give a visual reference for continual cursor movement. In some cases, only swipe gestures made with a minimum of two contact points invoke the keyboard cursor swipe mode. In some cases, the keyboard cursor swipe mode includes a highlighting feature that is triggered when a highlight activation action is used in combination with the swipe gesture. In some such cases, the highlight activation action includes at least one of a held stationary contact point, a pre-selected shift key, or a held shift key.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to invoke a keyboard cursor swipe mode in a device capable of displaying content in response to user input via a touch sensitive interface of the device (wherein the user input including a swipe gesture started anywhere on a virtual keyboard of the device to indicate a desired direction of cursor movement), and move the cursor in the desired direction. In some cases, the keyboard cursor swipe mode is configured to translate swipe gestures into only horizontal cursor movement, only horizontal and vertical cursor movement, or multi-directional cursor movement. In some cases, the cursor movement is based on the swipe gesture length, swipe gesture speed, number of contact points used for the swipe gesture and/or whether the swipe gesture is held. In some cases, the keyboard cursor swipe mode includes a highlighting feature, the highlighting feature triggered when a highlight activation action is used in combination with the swipe gesture. In some cases, the swipe gesture is made using two or more fingers and cursor movement tracks the direction of the swipe gesture.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive surface for allowing user input; and
a user interface including a virtual keyboard, wherein a swipe gesture performed on the virtual keyboard without regard to the starting contact point causes cursor movement determined by the direction of the swipe gesture.

2. The device of claim 1 wherein the display is a touch screen display that includes the touch sensitive surface.

3. The device of claim 1 wherein the cursor movement is based on the swipe gesture length, swipe gesture speed, number of contact points used for the swipe gesture and/or whether the swipe gesture is held.

4. The device of claim 1 wherein a path and/or starting point of the swipe gesture is indicated on the display to provide visual feedback.

5. The device of claim 1 wherein the swipe gesture is made using two or more fingers.

6. The device of claim 1 wherein the swipe gesture is made using two or more fingers and cursor movement tracks direction of the swipe gesture.

7. The device of claim 1 wherein the cursor movement in response to swipe gestures performed on the virtual keyboard is user-configurable.

8. A mobile computing device, comprising:
a display having a touch screen interface and for displaying content to a user; and
a user interface including a virtual keyboard and a keyboard cursor swipe mode that is configured to be invoked in response to user contact via the touch sensitive interface, the user contact including a swipe gesture starting on the virtual keyboard and causing cursor movement determined by the direction of the swipe gesture, wherein the length, speed, and/or number of contact points of the swipe gesture defines the distance and/or speed of the cursor movement.

9. The device of claim 8 wherein the keyboard cursor swipe mode is configured to translate swipe gestures into only horizontal cursor movement, only horizontal and vertical cursor movement, or multi-directional cursor movement.

10. The device of claim 8 wherein the keyboard cursor swipe mode is configured to cause continual cursor movement in response to held swipe gestures.

11. The device of claim 8 wherein the keyboard cursor swipe mode is configured to set the start of the swipe gesture as an anchor point about which the user can swipe to cause continual cursor movement.

12. The device of claim 11 wherein the anchor point is displayed to give a visual reference for continual cursor movement.

13. The device of claim 8 wherein only swipe gestures made with a minimum of two contact points invoke the keyboard cursor swipe mode.

14. The device of claim 8 wherein the keyboard cursor swipe mode includes a highlighting feature that is triggered when a highlight activation action is used in combination with the swipe gesture.

15. The device of claim 14 wherein the highlight activation action includes at least one of a held stationary contact point, a pre-selected shift key, or a held shift key.

16. A computer program product comprising a plurality of instructions non-transiently encoded thereon to facilitate operation of an electronic device according to the following process, the process comprising:
in response to user input via a touch sensitive interface of a device capable of displaying content, invoke a keyboard cursor swipe mode in the device, wherein the user input includes a swipe gesture started anywhere on a virtual keyboard of the device to indicate a desired direction of cursor movement; and
move the cursor in the desired direction.

17. The computer program product of claim 16 wherein the keyboard cursor swipe mode is configured to translate swipe gestures into only horizontal cursor movement, only horizontal and vertical cursor movement, or multi-directional cursor movement.

18. The computer program product of claim 16 wherein the cursor movement is based on the swipe gesture length, swipe gesture speed, number of contact points used for the swipe gesture and/or whether the swipe gesture is held.

19. The computer program product of claim 16 wherein the keyboard cursor swipe mode includes a highlighting feature, the highlighting feature triggered when a highlight activation action is used in combination with the swipe gesture.

20. The computer program product of claim 16 wherein the swipe gesture is made using two or more fingers and cursor movement tracks the direction of the swipe gesture.
